(19) United States
(12) Patent Application Publication
(10) Pub. No.: US 2014/0060753 A1
(43) Pub. Date: Mar. 6, 2014

(54) TIRE BEAD WEDGE PLIERS

(71) Applicants: Michael WHITE, Montgomery City, MO (US); Dylan LUNDBERG, Lonsdale, MN (US)

(72) Inventors: Michael WHITE, Montgomery City, MO (US); Dylan LUNDBERG, Lonsdale, MN (US)

(73) Assignee: SPX CORPORATION, Charlotte, NC (US)

(21) Appl. No.: 13/599,811

(22) Filed: Aug. 30, 2012

(51) Int. Cl. B60C 25/01

(52) U.S. Cl. 157/5

(57) ABSTRACT

A tire mounting tool configured to maintain a tire with respect to a wheel during a tire mounting process includes a wheel holding portion configured to be affirmatively held with respect to a rim of a wheel. The tire mounting tool further includes a handle portion configured to connect to and hold, at least in part, the wheel holding portion, and a tire holding portion configured to limit movement of the tire with respect to the rim of the wheel.

### FIELD OF THE INVENTION

The invention relates generally to a tool to maintain a bead of a tire during the tire mounting process. More particularly, the invention relates to a tool that can clamp to a wheel to maintain a bead of a tire during the tire mounting process. The invention also relates to a tool that can hold a bead in place and help to keep the bead in the drop center of the wheel.

### BACKGROUND OF THE INVENTION

The majority of vehicles currently operated use tires without tubes. These tubeless tires are typically mounted to a wheel, and the physical connection between the wheel and the tire is referred to as the bead. When initially mounting tires to the wheels, especially when manually mounting tires by hand, often times there is a difficulty in seating the tire on the wheel to form the bead. This is especially true in larger trucks and agricultural vehicles in that the tire and wheel are larger and create more difficulty in mounting the tire to the wheel to help form the bead. Moreover, the issue with larger wheels and tires is exasperated by the fact that a tire technician must struggle with the greater size and the weight of the combination of the two.

In particular, the larger and heavier tires tend to move with respect to the wheel and/or rim thereby preventing the formation of the bead. This requires the tire technician to reseat the bead, which results in wasted time and added frustration in the tire mounting process.

Accordingly, there is a need for a tool and associated process that can hold a bead in place and help to keep the bead in the drop center of the wheel. Moreover, there is a need for a tool and associated process to prevent tires from moving during the tire mounting process in order to make the tire mounting process easier, more time efficient and the like.

### SUMMARY OF THE INVENTION

The foregoing needs are met, to a great extent, by the invention, wherein one aspect tire bead wedge pliers is provided having a wheel holding portion and a tire-holding portion. This allows the tire technician to more easily mount a tire onto the rim of the wheel.

In accordance with one aspect of the invention a tire mounting tool is configured to maintain a tire with respect to a wheel during a tire mounting process including a wheel holding portion configured to be affirmatively held with respect to a rim of a wheel, a handle portion configured to connect to and hold, at least in part, the wheel holding portion, and a tire holding portion configured to limit movement of the tire with respect to the rim of the wheel.

The tire holding portion may connect to at least one of the handle and the wheel holding portion. The wheel holding portion may include first and second jaws. The first and second jaws may include a synthetic material coating to limit damage to the rim of the wheel. The first and second jaws may include a non-slip material to reduce movement between the first and second jaws and the rim of the wheel. The first and second jaws may include a construction that is wider than the remaining portion of the tire bead wedge pliers. The tire holding portion may be pivotally connected to the handle. The tire holding portion may be pivotally connected to the wheel holding portion. The tire holding portion may be substantially U-shaped. The handle portion may be configured to clamp the wheel holding portion onto the wheel. The tire mounting tool may further include a locking handle configured to cooperate with the handle portion to clamp the wheel holding portion onto the rim. The tire mounting tool may further include a locking handle that connects to a bar that connects to the handle. The tire mounting tool may further include a threaded boss and a thumbwheel associated with threaded boss to adjust a distance between the first and second jaws. In accordance with a further aspect of the invention a tire mounting tool configured to maintain a tire with respect to a wheel during a tire mounting process includes a wheel holding portion configured to be affirmatively held with respect to a rim of a wheel, a handle portion configured to connect to and hold, at least in part, the wheel holding portion, and a tire holding portion configured to limit movement of the tire with respect to the rim of the wheel, where the tire holding portion connects to at least one of the handle and the wheel holding portion, and where the wheel holding portion comprises first and second jaws.

The first and second jaws may include a construction that is wider than the remaining portion of the tire bead wedge pliers. The tire holding portion may be pivotally connected to the handle. The tire mounting tool and further include a locking handle configured to cooperate with the handle portion to clamp the wheel holding portion onto the rim.

In a further aspect of the invention a tire mounting tool configured to maintain a tire with respect to a wheel during a tire mounting process includes means for holding a wheel configured to be affirmatively held with respect to a rim of a wheel, handle means configured to connect to and hold, at least in part, the wheel holding means, and means for holding a tire portion to limit movement of the tire with respect to the rim of the wheel, where the tire holding means connects to at least one of the handle means and the wheel holding means, and where the wheel holding means comprises first and second jaws.

The first and second jaws may include a construction that is wider than the remaining portion of the tool. The tire mounting tool may further include a locking handle configured to cooperate with the handle means to clamp the wheel holding means onto the rim.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the present invention.

### BRIEF DESCRIPTION OF THE DRAWINGS

FIG. 1 shows a front perspective view of an aspect of the tire bead wedge pliers constructed according to the invention.

FIG. 2 shows a side view of an aspect of the tire bead wedge pliers constructed according to the invention.

FIG. 3 shows a perspective side view of an aspect of the tire bead wedge pliers clamped to a wheel during a tire mounting process according to the invention.

FIG. 4 shows a close-up side view of an aspect of the tire bead wedge pliers clamped to a wheel during a tire mounting process according to the invention.

### DETAILED DESCRIPTION

A tire wedge bead tool is provided that includes a tire-holding portion and a wheel-holding portion constructed to clamp to the rim of a wheel so that tires cannot easily move during the tire mounting process. The use of the tire wedge bead tool according to the invention makes the mounting of tires to wheels easier, faster, and more efficient. Furthermore, the use of the tire wedge bead tool according to the invention holds a bead in place and helps to keep the bead in the drop center of the wheel.

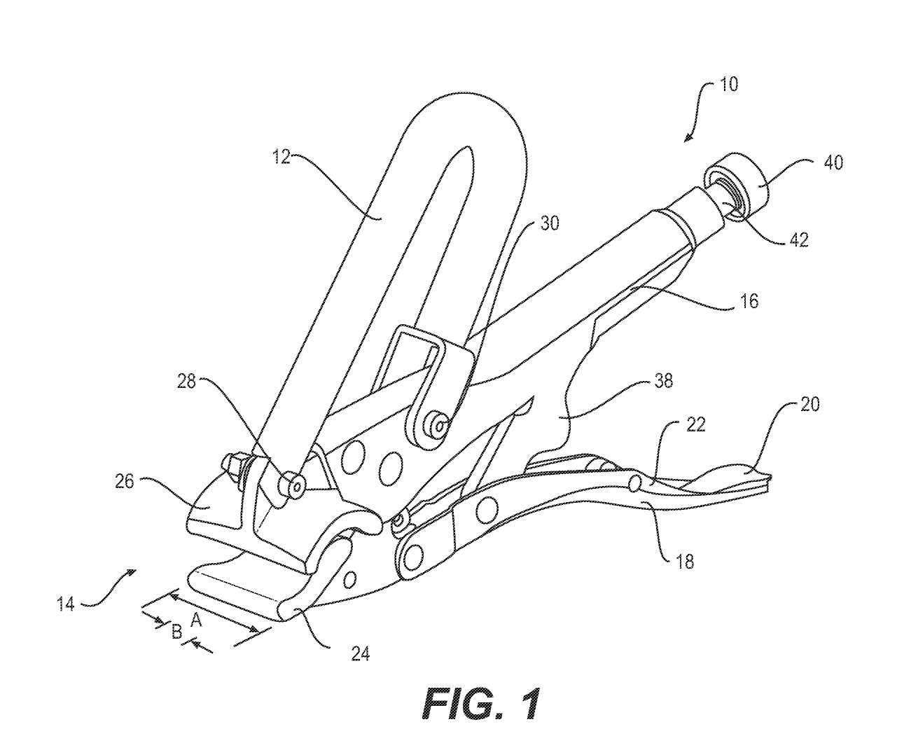

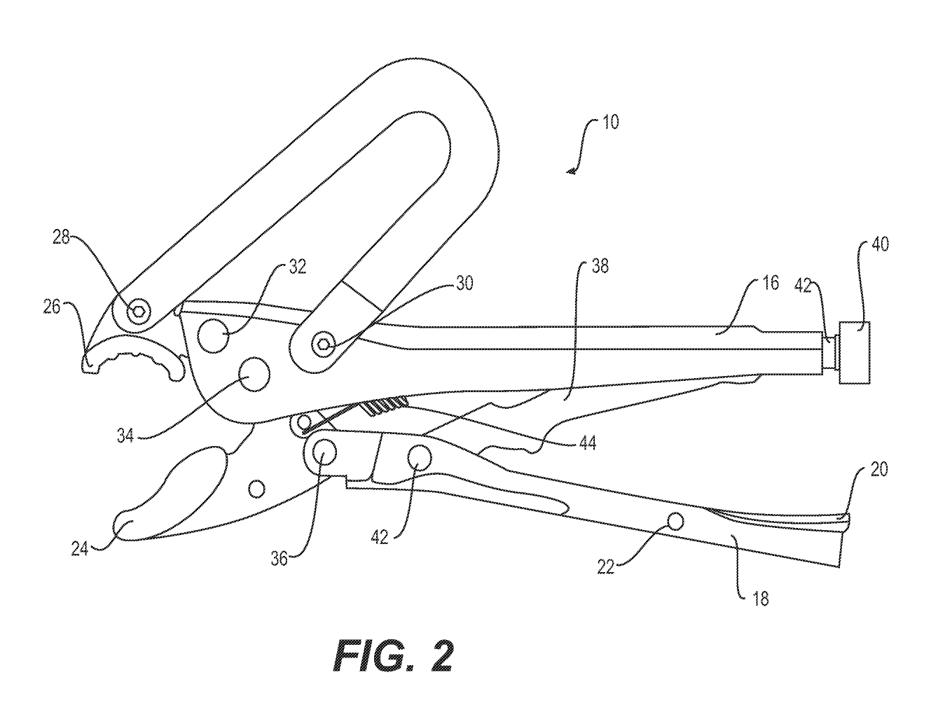

FIG. 1 shows a front perspective view of an aspect of the tire bead wedge pliers constructed according to the invention; and FIG. 2 shows a side view of an aspect of the tire bead wedge pliers constructed according to the invention. In particular, FIGS. 1 and 2 shows a tire-holding portion 12 that is arranged and configured to contact a tire that is being mounted to a wheel. Alternatively, the tire-holding portion 12 may be arranged and configured to contact a tire should it move too far vertically during the tire mounting process.

Additionally, FIG. 1 shows a wheel holding portion 14 that holds the tire bead wedge pliers 10 to the wheel such that the tire-holding portion 12 contacts the tire or contacts the tire should it move too far vertically during the tire mounting process. In this arrangement, a service technician may arrange the tire bead wedge pliers 10 such that the wheel holding portion 14 is firmly held onto the rim of a wheel and the tire-holding portion 12 is arranged such that it extends from the rim to substantially prevent the tire from moving in a manner to dismount the tire and/or break of the bead with respect to the tire and the wheel.

The wheel-holding portion 14 may be constructed to have a first jaw portion 24 and a second jaw portion 26. The combination of the first jaw portion 24 and the second jaw portion 24 may form a clamp that may be used by the tire technician to attach the tire bead wedge pliers 10 to the edge of the wheel or rim. The first jaw portion 24 and/or second jaw portion 26 may include a rubber coating and/or may be padded to prevent or lessen damage to the wheel. The first jaw portion 24 and/or second jaw portion 26 may have a non-slip surface to prevent or reduce sliding or other movement of the tire bead wedge pliers 10 with respect to the wheel or the like. Additionally the first jaw portion 24 and second jaw portion 26 may be internally formed of a metallic material for increased strength.

The first jaw portion 24 and the second jaw portion 26 may include a wider construction (see arrow A) as compared to the width of the remaining portion (see Arrow B) of the tire bead wedge pliers 10. This wider construction may prevent the tire bead wedge pliers 10 from moving with respect to the rim 10.

The tire-holding portion 12 may extend from a portion of the tire bead wedge pliers 10 with an angle such that when the first jaw portion 24 and second jaw portion 26 are attached to the rim of the wheel and the tire-holding portion 12 extends such that it is substantially parallel and in contact or close to the tire. The distance of the tire-holding portion 12 to the tire may be any particular distance so long as it is a prevents the tire from moving past the edge of the rim, moving such that it is difficult to mount the tire, or the like.

The tire-holding portion 12 may take any shape and/or arrangement such that when the tire bead wedge pliers 10 is attached to the rim of the wheel that the tire is more easily mounted to the wheel by preventing too much movement of the tire with respect to the wheel. Accordingly, a generally U-shaped construction of the tire-holding portion 12 works to meet this requirement, however other arrangements are also possible and contemplated by the invention herein.

In some arrangements, the tire-holding portion 12 may be pivotally connected to the tire bead wedge pliers 10. In this regard, the tire-holding portion 12 may include a first tire-holding portion pivot 28 and a second tire-holding portion pivot 30. These pivots are optional, but may allow the tire-holding portion 12 to move with respect to the tire bead wedge pliers 10 when the wheel holding portion 14 moves, allowing the tire technician some flexibility in the positioning of the tire bead wedge pliers 10 with respect to the rim of the wheel. Additionally the tire-holding portion 12 pivots along the first tire pivot holding portion pivot 28 and second tire-holding portion pivot 32. The movement of the second jaw portion 26 may allow the tire-holding portion 12 to pivot along with the second jaw portion 26.

In a particular aspect, the tire bead wedge pliers 10 may include a handle 16 that allows for the tire technician to be able to easily grasp the tire bead wedge pliers 10 and arrange it on the wheel rim as desired. Additionally the handle 16 may provide a construction, which allows the tire-holding portion 12 and the second jaw portion 26 to pivot thereabout. In this regard, the first tire holding portion pivot 28 may be connected to the handle 16 via a pivot 32. As previously mentioned, the tire-holding portion 12 may include a second tire-holding portion pivot 30, this pivot 30 may be connected to the handle 16 as well. Additionally, the first jaw portion 24 may also be pivotally connected to the handle 16. In this regard, the first jaw portion 24 may be pivotally connected through a pivot 34 to the handle 16. The above-mentioned pivots can be formed by any type of mechanical fastener. As shown by FIG. 1 and FIG. 2, the pivots 32, 34 may be implemented as rivets. Of course, any type of mechanical fasteners are contemplated by the invention. For example, the pivots 28, 30 are implemented as mechanical fasteners in the form of a bolt having Allen wrench head and a hex head nut. Again, any type of mechanical fasteners are contemplated by the invention and are within spirit of scope hereof.

The tire bead wedge pliers 10 may be further implemented as a clamping mechanism. In this regard, the invention contemplates that the first jaw portion 24 and second jaw portion 26 may be configured such that they are held in a clamped manner to the wheel rim. The clamping capability allows the tire technician to be able to arrange the tire bead wedge pliers 10 to the wheel and continue with the tire mounting process without having to hold the tire bead wedge pliers 10.

In a particular aspect, the tire bead wedge pliers 10 may include a locking arrangement so as to provide the clamping capability. In such an arrangement as shown in FIGS. 1 and 2, attached to the first jaw portion 24 may be a locking handle 18. The locking handle 18 may connect to the first jaw portion 24 through a locking handle pivot 36. Additionally the tire bead wedge pliers 10 may include a bar 38. The bar 38 may be connected to the locking handle 18 through pivot 46. The bar 38 may extend into handle 16 and provide a clamping configuration to the tire bead wedge pliers 10. The bar 38 may contact a threaded boss 42. The threaded boss 42 may extend into the handle 16. A thumbwheel 40 may be connected to the end of the threaded boss 42. The thumbwheel 40 may allow the tire technician to rotate the boss 42 easily with respect to the handle 16. Rotating the boss 42 into or out of the handle 16 moves the bar 38 position so as to change the distance between the second jaw portion 26 and first jaw portion 24 during their clamped configuration. Finally, a tension spring 44 may be arranged between the first jaw portion 24 and the handle 16 so as to hold the bar 38 with respect to the boss 42. The combination of the locking handle 18, the bar 38, the tension spring 44, and the threaded boss 40 may provide a clamping construction for the tire bead wedge pliers 10. Of course, it should be noted that the tire bead wedge player 10 does not have to implement the clamping construction as described above respect FIGS. 1 and 2 and can use any type of clamping construction. For example, the first jaw portion 24 and the second jaw portion 26 may be clamped together with the any known type of apparatus or construction that holds the first jaw portion 24 in the second jaw portion 26 in a robust holding arrangement. Moreover, the tire bead wedge pliers 10 can use a non-clamping construction and such is within the scope and spirit of the invention.

Optionally, the tire bead wedge pliers 10 may further include a release handle 20. The release handle 20 may be pivotally connected through a release handle pivot the 22 to the locking handle 18. Operation of the release handle 20 disengages the clamped nature of the locking handle 18 to the handle 16 and allows the tire technician to quickly and easily remove the tire bead wedge pliers 10 from the locked configuration.

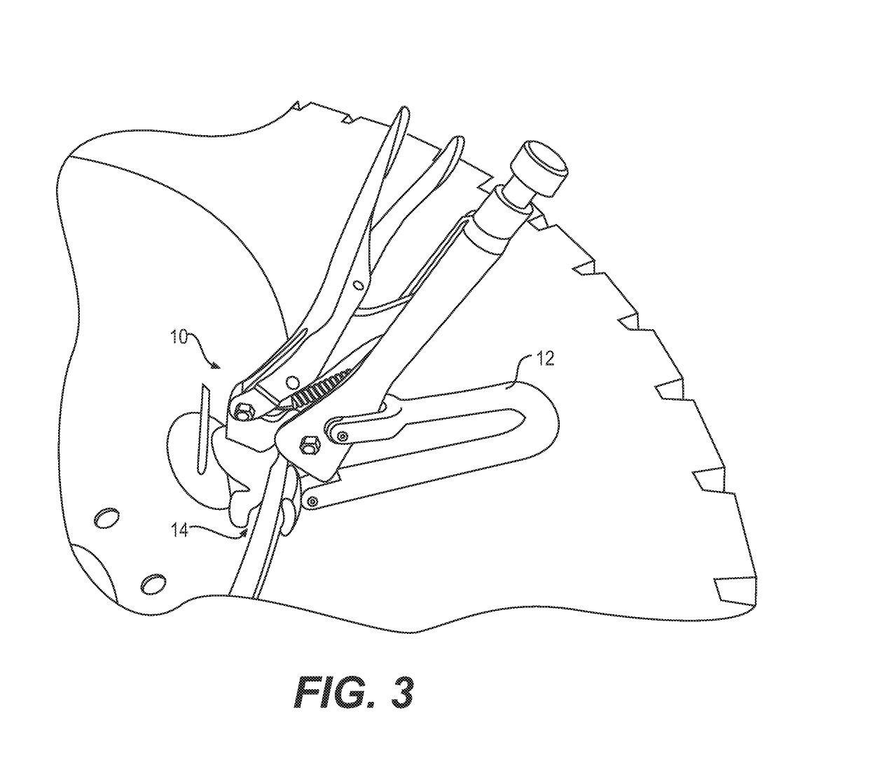

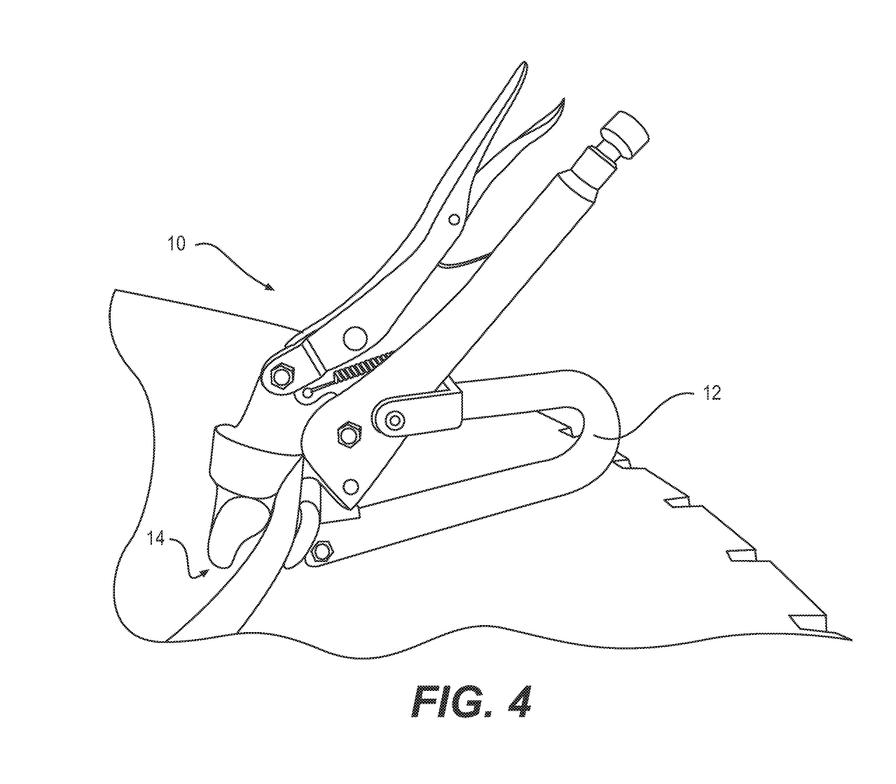

As shown by FIGS. 3 and 4, when a tire technician desires to mount a tire to a rim, the tire technician can take the tire bead wedge pliers 10 and attach it to the rim of the wheel as shown in FIGS. 3 and 4. Prior to attaching the tire bead wedge pliers 10 to the rim, the tire technician may adjust the distance between the first jaw portion 24 and the second of portion the 26 by adjusting the thumbwheel 40. In this regard, adjusting the thumbwheel 40 may modify the distance between the first portion 24 and the second of portion 26 to handle different width and/or size rims or different rim configurations. Once the tire bead wedge pliers 10 is attached and clamped to the rim of the wheel, the angle of the tire-holding portion 12 may be adjusted such that the tire movement will be limited. In this regard, the tire technician can move and adjust the position of the tire bead wedge pliers 10 with respect to the rim to allow the tire-holding portion 12 to be positioned optimally with respect to the tire. Thereafter, the tire technician may continue to install the tire onto the wheel and the tire bead wedge pliers 10 may substantially maintain the tire with respect to the rim in order to properly form a bead. Once the tire is correctly mounted onto the wheel, a proper bead is formed or ready to be formed, the tire technician can then remove the tire bead wedge pliers 10 from the rim and the tire may be inflated. If not already installed on the vehicle, the wheel may then be installed on the vehicle.

In alternative approach, the tire technician may arrange the tire bead wedge pliers 10 onto the rim of the wheel while the wheel is attached to the vehicle and the tire only partially mounted. Thereafter, the wheel may be rotated while on the vehicle and the tire installed consistent with the above-noted process.

In a particular aspect, the tire technician may mount the tire onto the wheel of a vehicle by hand while the vehicle wheel is still attached to the vehicle. During this mounting process, the tire bead pliers 10 may be mounted to the wheel had a particular location. The tire technician may then use tire mounting spoons or similar tool to guide the remaining part of the tire onto the wheel by rotating the wheel of the vehicle to mount the tire fully onto the wheel.

Accordingly, the invention provides a tire bead wedge pliers 10 that allows a tire technician to quickly and easily arrange a tire onto a rim to which the tires are to be mounted to. The tire-holding portion 12 limits movement of the tire with respect to the wheel rim thus making it easier for the tire technician to complete the mounting of the tire to the wheel and the formation of a bead between the tire and the wheel. Additionally, the invention provides a tire bead wedge pliers 10 that can hold a bead in place and help to keep the bead in the drop center of the wheel.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A tire mounting tool configured to maintain a tire with respect to a wheel during a tire mounting process comprising:
a wheel holding portion configured to be affirmatively held with respect to a rim of a wheel;
a handle portion configured to connect to and hold, at least in part, the wheel holding portion; and
a tire holding portion configured to limit movement of the tire with respect to the rim of the wheel.

2. The tire mounting tool according claim 1 wherein the tire holding portion connects to at least one of the handle and the wheel holding portion.

3. The tire mounting tool according claim 1 wherein the wheel holding portion comprises first and second jaws.

4. The tire mounting tool according claim 3 wherein the first and second jaws comprise a synthetic material coating to limit damage to the rim of the wheel.

5. The tire mounting tool according claim 3 wherein the first and second jaws comprise a non-slip material to reduce movement between the first and second jaws and the rim of the wheel.

6. The tire mounting tool according claim 3 wherein the first and second jaws comprise a construction that is wider than the remaining portion of the tire bead wedge pliers.

7. The tire mounting tool according claim 1 wherein the tire holding portion is pivotally connected to the handle.

8. The tire mounting tool according claim 1 wherein the tire holding portion is pivotally connected to the wheel holding portion.

9. The tire mounting tool according claim 1 wherein the tire holding portion is substantially U-shaped.

10. The tire mounting tool according claim 1 wherein the handle portion is configured to clamp the wheel holding portion onto the wheel.

11. The tire mounting tool according claim 1 further comprising a locking handle configured to cooperate with the handle portion to clamp the wheel holding portion onto the rim.

12. The tire mounting tool according claim 1 further comprising a locking handle that connects to a bar that connects to the handle.

13. The tire mounting tool according claim 3 further comprising a threaded boss and a thumbwheel associated with threaded boss to adjust a distance between the first and second jaws.

14. A tire mounting tool configured to maintain a tire with respect to a wheel during a tire mounting process comprising:
a wheel holding portion configured to be affirmatively held with respect to a rim of a wheel;
a handle portion configured to connect to and hold, at least in part, the wheel holding portion; and
a tire holding portion configured to limit movement of the tire with respect to the rim of the wheel,
wherein the tire holding portion connects to at least one of the handle and the wheel holding portion; and
wherein the wheel holding portion comprises first and second jaws.

15. The tire mounting tool according claim 14 wherein the first and second jaws comprise a construction that is wider than the remaining portion of the tire bead wedge pliers.

16. The tire mounting tool according claim 14 wherein the tire holding portion is pivotally connected to the handle.

17. The tire mounting tool according claim 14 further comprising a locking handle configured to cooperate with the handle portion to clamp the wheel holding portion onto the rim.

18. A tire mounting tool configured to maintain a tire with respect to a wheel during a tire mounting process comprising:
means for holding a wheel configured to be affirmatively held with respect to a rim of a wheel;
handle means configured to connect to and hold, at least in part, the wheel holding means; and
means for holding a tire portion to limit movement of the tire with respect to the rim of the wheel,
wherein the tire holding means connects to at least one of the handle means and the wheel holding means; and
wherein the wheel holding means comprises first and second jaws.

19. The tire mounting tool according claim 18 wherein the first and second jaws comprise a construction that is wider than the remaining portion of the tool.

20. The tire mounting tool according claim 18 further comprising a locking handle configured to cooperate with the handle means to clamp the wheel holding means onto the rim.
